(19) United States
(12) Patent Application Publication
(10) Pub. No.: US 2008/0053320 A1
(43) Pub. Date: Mar. 6, 2008

(54) Pad printing of video targets for strain measurement

(75) Inventor: Paulo A. Martin, Somerset, MA (US)

Correspondence Address: DAY PITNEY LLP;ACCOUNT: ILLINOIS TOOL WORKS INC., 7 TIMES SQUARE, NEW YORK, NY, 10036-7311, US

(73) Assignee: ILLINOIS TOOL WORKS INC.

(21) Appl. No.: 11/516,074

(22) Filed: Sep. 6, 2006

(51) Int. Cl. B41F 17/00

(52) U.S. Cl. 101/41

(57) ABSTRACT

The disclosure relates to pad printing of video targets on a specimen for tensile or similar testing by a video extensometer. The pad printer may include various improvements such as pneumatic pistons to vary the pad spacing; pad supports which vary their spacing between ink pick-up and printing thereby allowing for a range of printing for a given cliché or printing plate; automatic proportional gauge length calculation; and a combination of a mechanical boss and a magnetic plate to secure the printing pad to the pad carrier.

### BACKGROUND OF THE INVENTION

1. Field of the Invention

The present invention pertains to the use of a pad printer to place video targets on a sample for strain measurement by a video extensometer or similar device.

2. Description of the Prior Art

Video extensometers are disclosed in patent application Ser. No. 10/683,072 entitled “Testing of Samples”, filed on Oct. 10, 2003 and patent application Ser. No. 11/410,686 entitled “Testing of Samples”, filed on Apr. 24, 2006. These devices generate stress/strain curves for a tested sample. In order to measure the strain, which is calculated through the percentage of linear deformation of the sample under testing, video targets, such as two dots, are placed on the sample. The extensometer uses video methods to determine the change in distance between the targets during testing, thereby calculating the strain. As the cross-sectional area of the target is calculated prior to testing and the force applied to the target is recorded, the resulting stress can be correlated with the strain to generate a traditional stress/strain curve.

However, in the prior art, the generation of the video targets has been problematic. Manual use of a marking pen to apply the video targets does not have uniform results. Likewise, the use of punched adhesive backed paper to supply the dots is problematic in that the dots may not adhere properly to round or other than flat specimens, may require a considerable application force which may damage certain specimens, may interfere with the test results of thin films in that the rigidity of the dots may artificially increase the rigidity of the sample, and may not adhere evenly to a specimen as it stretches thereby interfering with the strain measurement. Additionally, the dots may fly from the specimen during testing, particularly when the specimen breaks. Dots within the line of sight of the extensometer may cause erroneous test results. At a minimum, such errant dots may clutter the testing area.

### OBJECTS AND SUMMARY OF THE INVENTION

It is therefore an object of the present invention to provide improvements in the marking of video targets on specimens for strain measurements.

This and other objects are attained by providing a pad printing device for the application of video targets on specimens for strain testing. Additionally, such improvements are attained by providing pneumatic pistons on the pad supports to automatically change the spacing of the pads thereby changing the spacing of the video targets; by providing pad supports which change spacing between the ink pick-up and the ink application thereby providing different video target spacing for a single spacing of ink wells in the printing plate (i.e., cliché) of the pad printer; by providing for automatic gauge length calculation; and by providing a snap-in magnetic configuration for securing the printing pads.

### BRIEF DESCRIPTION OF THE DRAWINGS

Further objects and advantages of the invention will become apparent from the following description and from the accompanying drawings, wherein:

FIG. 1 is a perspective view of a video extensometer performing stress/strain testing on a sample which includes video targets.

FIG. 2 is a plan view of a typical testing specimen with video targets.

FIG. 3 is a perspective view of a first embodiment of a pad printing device of the present invention.

FIG. 4 is a perspective view of a second embodiment of a pad printing device of the present invention.

FIG. 5 is a plan view of a cliché or printing plate for the pad printer of the present invention, showing typical spacing of the ink wells for the printing of video targets.

FIG. 6 is a schematic of an example of a gauge length pattern of dots on the cliché of FIG. 5, including typical dimensions.

FIG. 7 is a schematic showing the pistons to change the spacing of the printing pads between the ink pick-up and the printing.

FIG. 8 is a schematic of showing the apparatus for automatic proportional gauge length spacing of the video targets.

FIG. 9 is an exploded perspective view, partially in phantom, of the magnetic support configuration for the printing pads.

### DETAILED DESCRIPTION OF THE PREFERRED EMBODIMENT

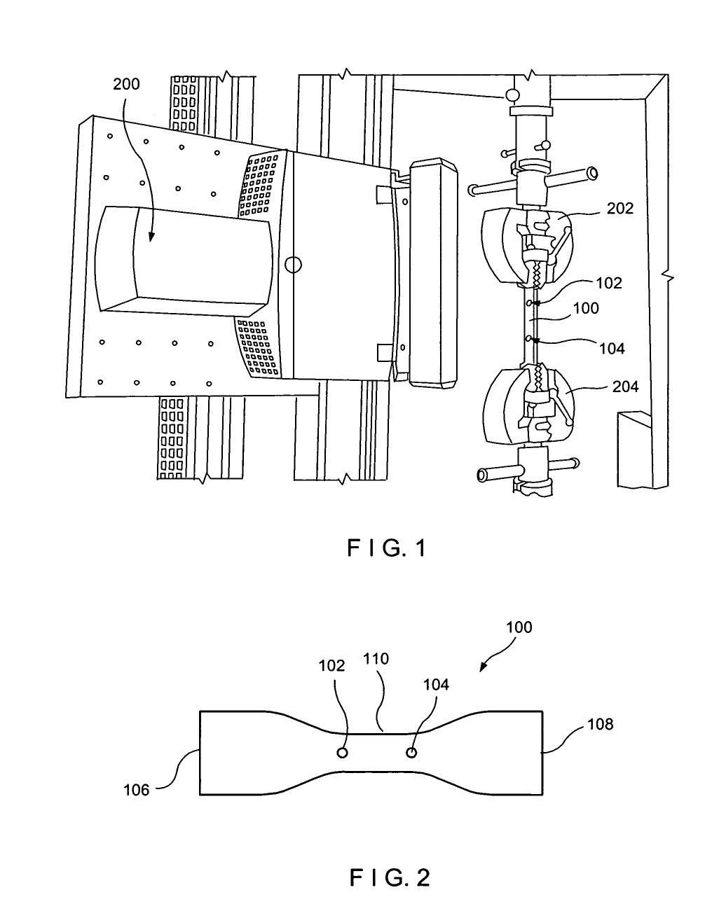

Referring now to the drawings in detail, wherein like numerals indicate like elements throughout the several views, one sees that FIG. 1 illustrates a specimen 100 undergoing stress/strain analysis by a video extensometer 200, such as that disclosed in patent application Ser. No. 10/683,072 entitled “Testing of Samples”, filed on Oct. 10, 2003 and patent application Ser. No. 11/410,686 entitled “Testing of Samples”, filed on Apr. 24, 2006.

Specimen 100 (shown in detail in FIG. 2 and discussed below) is held between two sample holders or grips 202, 204 which typically exert a pulling force on the specimen to perform tensile testing. By dividing the pulling force by the cross-sectional area of the central part (i.e., the smallest cross-sectional area) of the specimen 100, the stress is calculated. The measurement of this force and of the cross-sectional area, as well as the calculations, are straightforward. In order to calculate the strain on the portion of interest of the specimen, corresponding to the stress, the relative elongation of the portion of interest of the specimen must be measured. Video targets 102, 104 are placed on the portion of interest of the specimen so that the video extensometer 200 can detect the relative deformation of the portion of interest of the specimen 100.

A typical shape of the specimen 100 is illustrated in FIG. 2. Specimen 100 is typically formed from a planar material of relatively uniform thickness. Specimen 100 includes two ends 106, 108 with increased width in order to be engaged firmly by sample holders or grips 202, 204. A central section 110 is formed between two ends 106, 108. Central section 110 typically includes a section with parallel edges and the least width of the specimen 100, so that relatively uniform stress can be applied to a given section of minimum cross section (and hence maximum stress). Video targets 102, 104 are typically placed on central section 110.

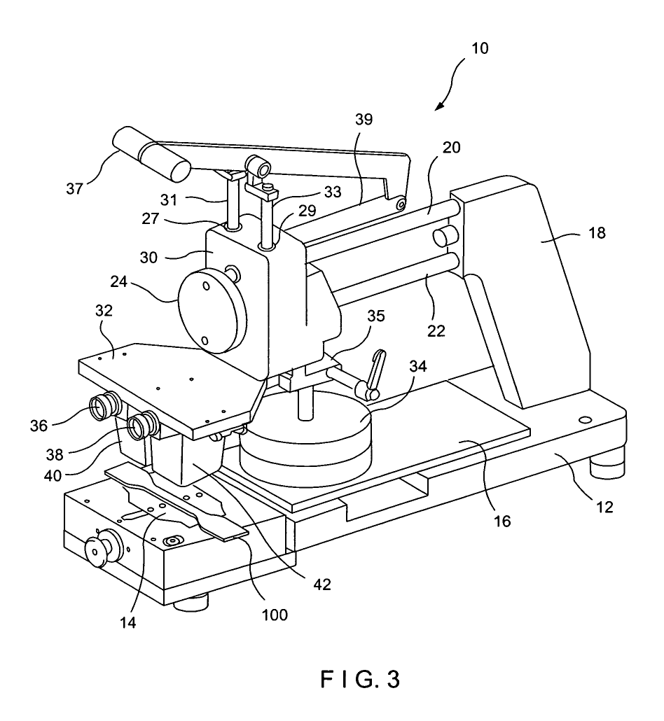

A first embodiment of a pad printer 10 for the printing of video targets 102, 104 is shown in FIG. 3. A ground engaging base 12 holds a locating device 14 for positioning specimen 100 for printing and further provides a support for cliché or printing plate 16. Base 12 further engages support 18 which engages the proximal ends of rails 20, 22 and from which rails 20, 22 extend. Stop 24 is formed at the distal ends of rails 20, 22. Reciprocating head 30 includes vertical passageways 27, 29 through which vertical rails 31, 33 pass to provide for vertical movement of carrier plate 32. This vertical movement can be provided electromechanically or can be provided manually through handle 37 which engages vertical rails 31, 33 and pivots at a distal end of pivot extension 39 which extends from reciprocating head 30.

Reciprocating head 30 further supports ink cup shaft 35 for inverted ink cup 34. Inverted ink cup 34 includes magnets to urge the ink cup 34 against the cliché or printing plate 16 and prevent leakage of the ink as the ink cup 34 is moved across the cliché or printing plate 16 by ink cup shaft 35. These magnets further eliminate the need for ink cup shaft 35 to provide a vertical pressing force to the inverted ink cup 34 as the ink cup 34 is moved across the cliché or printing plate 16. Pad carriers 36, 38 are attached to the underside of carrier plate 32. Printing pads 40, 42 are attached to pad carriers 36, 38. The central portions of printing pads 40, 42 are spaced apart by a distance equal to the desired distance between the video targets. Printing pads 40, 42 are typically sufficiently soft to conform to any round or non-flat contours of the object receiving the printed pattern.

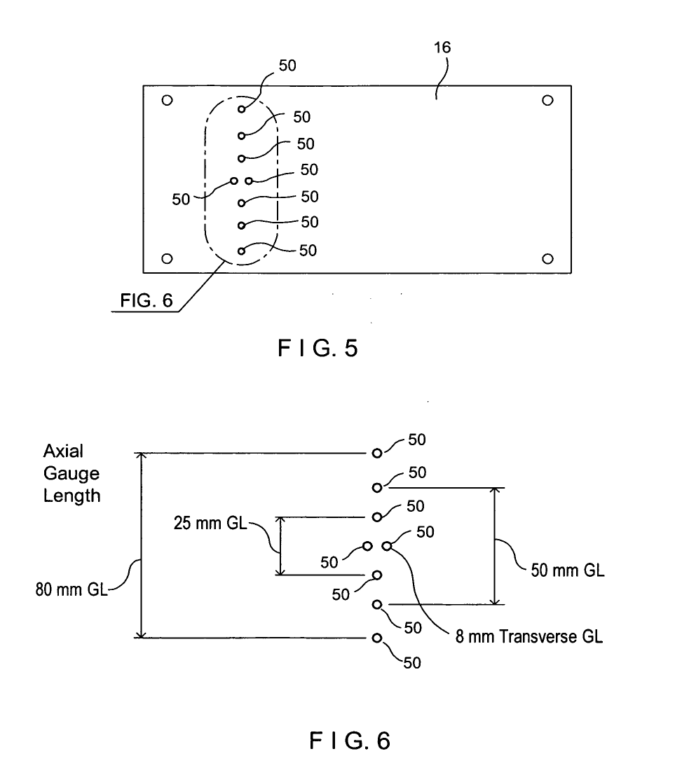

As is known in the art of pad printing, cliché or printing plate 16 includes a pattern of indentations 50 (see FIGS. 5 and 6). These indentations 50 collect ink from the inverted ink cup 34 as the inverted ink cup 34 is magnetically urged against the cliché or printing plate 16 during each printing cycle. More particularly, the reciprocating head 30 travels from the distal end of rails 20, 22 (the illustrated position in FIG. 3) to the proximal end of rails 20, 22 thereby moving the inverted ink cup 34 away from the ink-filled indentations 50 and positioning printing pads 40, 42 for vertical movement thereby dipping into indentations 50 and drawing ink therefrom. The reciprocating head 30 then travels back to the distal end of rails 20, 22 thereby moving the inverted ink cup 34 over indentations 50 in order to replenish the ink in indentations 50 and positioning printing pads 40, 42 for vertical movement thereby printing video targets 102, 104 onto specimen 100.

FIG. 5 shows a typical pattern of indentations 50 on cliché or printing plate 16 for the printing of video targets 102, 104, while FIG. 6 gives the dimensions for various typical axial gauge length and transverse gauge length for the printing of video targets 102, 104. Transverse gauge length video targets may be printed by a single printing pad in a central location on the pad printer 10.

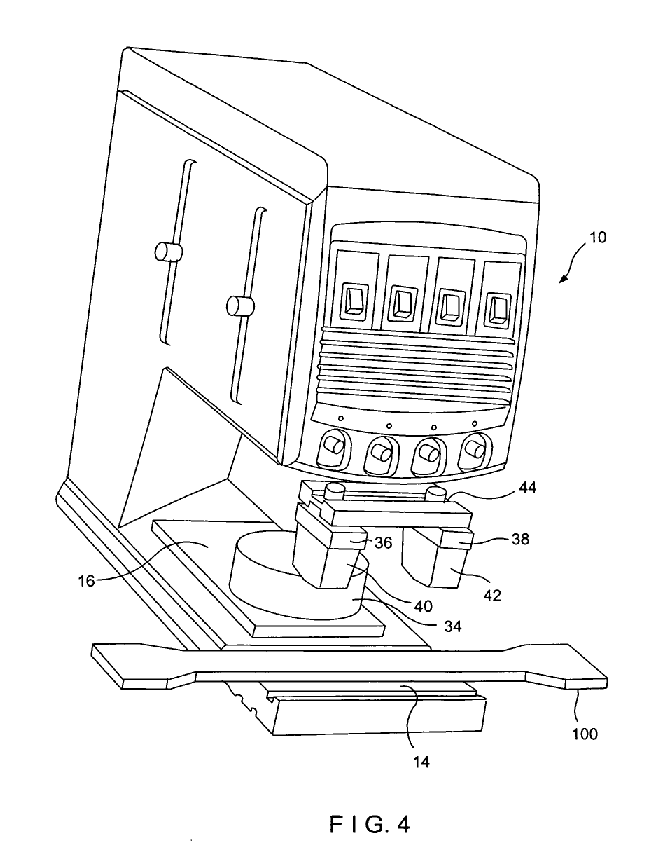

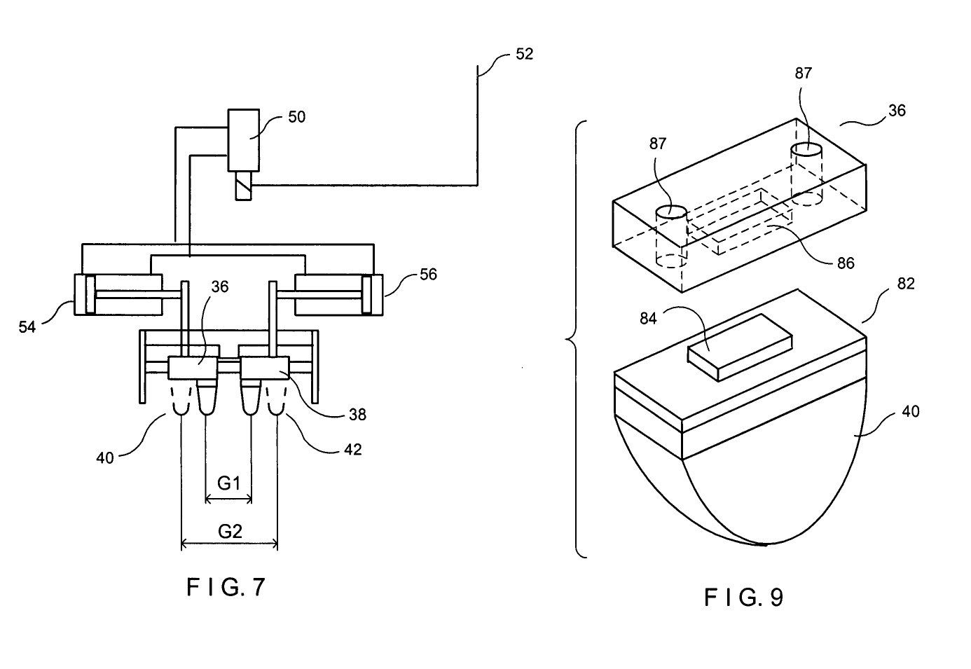

FIG. 4 shows a second embodiment of the pad printer 10, with similar elements and further including track 44 allowing for the adjustment of the position and spacing of pad carriers 36, 38 and hence printing pads 40, 42. This allows for the automated changing of the spacing or separation of the printing pads 40, 42 by the use of pneumatics or motors and is shown in more detail in FIG. 7. Solenoid valve 50, in response to electronic input from line 52, activates pistons 54, 56 to move the positions of printing pads 40, 42, so that various gauge lengths can be achieved, including the illustrated G1 and G2 gauge lengths. Additionally, this configuration can be used to change the spacing of the printing pads 40, 42 between the ink pick-up and the printing steps. This is very useful in that different spacing of the printed video targets 102, 104 can be achieved without the need to form a new set of indentations 50 in the cliché or printing plate 16 and likewise without the need to partially disassemble pad printer 10 to install a new cliché or printing plate 16 when a different gauge length is needed. More specifically, the indentations 50 can be formed at a first gauge length and the printing pads 40, 42 are set to this gauge length during the ink pick-up step, and then the pistons 54, 56 can change the spacing of the printing pads 40, 42 to a second gauge length prior to the printing of the video targets 102, 104. This is particularly useful when gauge lengths are desired which are wider than the cliché 16 or the ink cup 34.

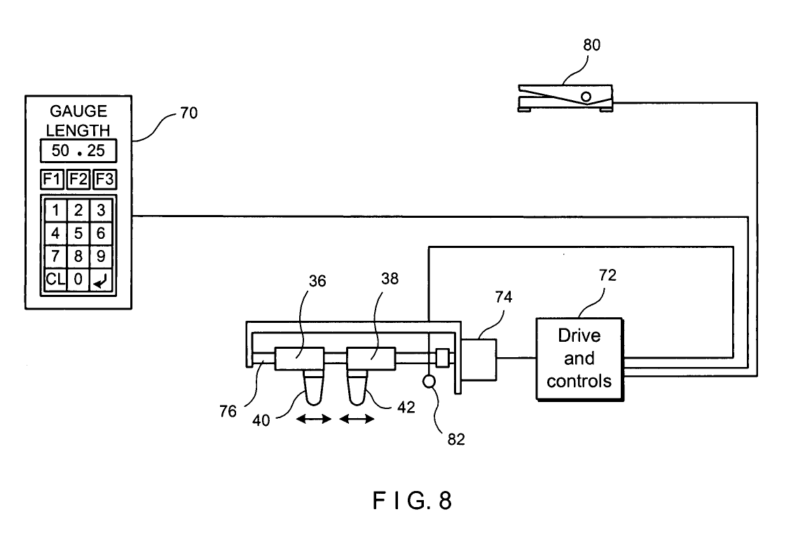

A similar embodiment is disclosed in FIG. 8 which allows automatic proportional gauge length testing that meets the requirements of metals testing per JIS Z 2201, ISO 6892 Annex D and others that require that the gauge length be proportional to the square root of the cross-sectional area of the specimen 100. This is normally expressed as GL=k √A, where k is typically 5.65 (no units required for “k” as the square root of an area gives a linear distance). The value of cross-sectional area (A) can be determined using other instruments and methods known in the art and input to controller 70 through a keypad or similar device. Controller 70 generates input to drive and control box 72 which controls motor 74. Motor 74 drives screw shaft 76 which includes one half left hand threads and one half right hand threads. Pad carriers 36, 38 are threadably mounted on screw shaft 76 whereby rotation of screw shaft 76 in a first direction causes pad carriers 36, 38, and hence pads 40, 42, to move toward each other (decreasing the spacing therebetween) and rotation of screw shaft 76 in a second direction causes pad carriers 36, 38, and hence pads 40, 42, to move away from each other (increasing the spacing therebetween). Footswitch 80, or similar switch, is provided so that the user can initiate the desired operations. Limit switch 82 is provided to prevent movement of pad carriers 36, 38 beyond the operating limits of this embodiment and further acts as a reference or home position for the pad mechanism.

FIG. 9 discloses a configuration for the attachment of a printing pad 40 to a pad carrier 36 in such a way that the connection is sufficiently strong for the operation of pad printing, while still allowing for the simple and fast manual (“snap-in”) installation or removal of the printing pad 40. Printing pad 40 includes an upper metal plate 82 with a projecting male boss 84. Pad carrier 36 includes a blind slot 86 of complementary size and shape to the projecting male boss 84. The position of the projecting male boss 84 and the blind slot 86 can be reversed. Pad carrier 36 further includes magnets 87 to create a strong connection between the upper metal plate 82 and the pad carrier 36.

To use pad printer 10, the user confirms that the appropriate cliché or printing plate 16 is installed and that the printing pads 40, 42 are properly spaced. Some embodiments require further programming or adjustment if the spacing of the printing pads 40, 42 will be adjusted between ink pick-up and printing. The user places specimen 100 into adjustable locating device 14 and initiates the process so that video targets 102, 104 are printed on the specimen 100 in preparation for subsequent tensile or similar testing.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A process of printing at least one video target on a specimen for tensile testing, comprising the steps of:
providing a printing plate with at least one indentation therein;
providing a source of ink to said indentation;
positioning at least one printing pad into said at least one indentation thereby drawing ink therefrom; and
positioning said printing pad onto said specimen thereby printing at least one video target on a specimen with said ink.

2. The process of claim 1 wherein at least two video targets are printed, said printing plate includes at least two indentations and said positioning steps include at least two printing pads.

3. The process of claim 2 wherein said at least two video targets are spaced apart by a selected distance, said at least two indentations are spaced apart by said selected distance, and central portions of said at least two printing pads are spaced apart by said selected distance.

4. The process of claim 2 wherein said step of providing a source of ink comprises providing an inverted ink cup urged against said printing plate proximate to said at least two indentations.

5. The process of claim 4 further comprising the step of moving said inverted ink cup away from said indentations prior to said step of positioning the printing pads into said indentations.

6. The process of claim 5 further comprising the step of moving said ink cup back to said indentations simultaneously with said step of positioning the printing pads onto said specimen.

7. The process of claim 6 further including performing tensile testing on said specimen after said step of positioning the printing pads onto said specimen.

8. An apparatus for printing at least one video target on a specimen for tensile testing, comprising:
a printing plate with at least one indentation therein;
a source of ink to said indentation;
first means for positioning at least one printing pad into said at least one indentation thereby drawing ink therefrom; and
second means for positioning said printing pad onto said specimen thereby printing at least one video target on a specimen with said ink.

9. The apparatus of claim 8 wherein at least two video targets are printed, said printing plate includes at least two indentations and said first and second positioning means include at least two printing pads.

10. The apparatus of claim 9 wherein said at least two video targets are spaced apart by a selected distance, said at least two indentations are spaced apart by said selected distance, and central portions of said at least two printing pads are spaced apart by said selected distance.

11. The apparatus of claim 9 wherein said source of ink comprises an inverted ink cup urged against said printing plate proximate to said at least two indentations.

12. The apparatus of claim 11 further comprising means for moving said inverted ink cup away from said indentations prior positioning said printing pads into said indentations.

13. The apparatus of claim 12 further comprising means for moving said ink cup back to said indentations simultaneously with positioning said printing pads onto said specimen.

14. The apparatus of claim 13 further including means for positioning said specimen.

15. An apparatus for printing at least one video target on a specimen for tensile testing, comprising:
a printing plate with at least one indentation therein;
a source of ink to said indentation;
a reciprocating head including at least one printing pad, said reciprocating head having a first position wherein said at least one printing pad draws ink from said at least one indentation and a second position wherein said at least one printing pad prints at least one video target on said specimen.

16. The apparatus of claim 15 wherein at least two video targets are printed, said printing plate includes at least two indentations and said reciprocating head includes at least two printing pads.

17. The apparatus of claim 16 wherein said at least two video targets are spaced apart by a selected distance, said at least two indentations are spaced apart by said selected distance, and central portions of said at least two printing pads are spaced apart by said selected distance.

18. The apparatus of claim 16 wherein said source of ink comprises an inverted ink cup urged against said printing plate proximate to said at least two indentations when said reciprocating head is in said second position.

19. The apparatus of claim 18 wherein said inverted ink cup is positioned away from said at least two indentation when said reciprocating head is in said first position.

20. The apparatus of claim 19 further including a locating device for positioning said specimen.
